(19) United States
(12) Patent Application Publication
(10) Pub. No.: US 2007/0011287 A1
(43) Pub. Date: Jan. 11, 2007

(54) Systems and methods for seamless handover in a streaming data application

(76) Inventors: Charbel Khawand, Miami, FL (US); Jyh-Han Lin, Parkland, FL (US); Chin P. Wong, Parkland, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/130,448

(22) Filed: May 16, 2005

(51) Int. Cl. G06F 15/173

(52) U.S. Cl. 709/223

(57) ABSTRACT

A computing device (102) includes computer instructions for receiving (202) streaming data, delegating (204) portions of the streaming data to a plurality of processes (302-305), detecting (206) that one or more of the processes is affected by an interruption that would inhibit further processing of the portions of streaming data delegated thereto, and rerouting (214) to other available processes the portions of streaming data supplied to the one or more affected processes at a desired quality of service level.

### FIELD OF THE INVENTION

This invention relates generally to streaming data applications, and more particularly to systems and methods for seamless handover in a streaming data application.

### BACKGROUND OF THE INVENTION

In a multitasking operating environment it is common for streaming data having audio and/or video components to experience undesirable jitter and/or periodic interruptions.

### SUMMARY OF THE INVENTION

Embodiments in accordance with the invention provide systems and methods for seamless handover in a streaming data application.

In a first embodiment of the present invention, a multiprocessing system operating according to a method includes the steps of receiving streaming data, delegating portions of the streaming data to a plurality of processes, detecting that one or more of said processes is affected by an interruption that would inhibit further processing of the portions of streaming data delegated thereto, and rerouting to other available processes the portions of streaming data supplied to the one or more affected processes at a desired quality of service level.

In a second embodiment of the present invention, a computer-readable storage medium includes computer instructions for receiving streaming data, delegating portions of the streaming data to a plurality of processes, detecting that one or more of said processes is affected by an interruption that would inhibit further processing of the portions of streaming data delegated thereto, and rerouting to other available processes the portions of streaming data supplied to the one or more affected processes at a desired quality of service level.

In a third embodiment of the present invention, a device has a memory coupled to a computing device. Said computing device is programmed to receive streaming data, delegate portions of the streaming data to a plurality of processes operating on said computing device, detect that one or more of said processes is affected by an interruption that would inhibit further processing of the portions of streaming data delegated thereto, and reroute to other available processes the portions of streaming data supplied to the one or more affected processes at a desired quality of service level.

### BRIEF DESCRIPTION OF THE DRAWINGS

FIGS. 1-2 depict components of a device according to an embodiment of the present invention; and

FIGS. 3-4 depict a flow chart of a method and process diagram operating on the device according to an embodiment of the present invention.

### DETAILED DESCRIPTION OF THE DRAWINGS

While the specification concludes with claims defining the features of embodiments of the invention that are regarded as novel, it is believed that the embodiments of the invention will be better understood from a consideration of the following description in conjunction with the figures, in which like reference numerals are carried forward.

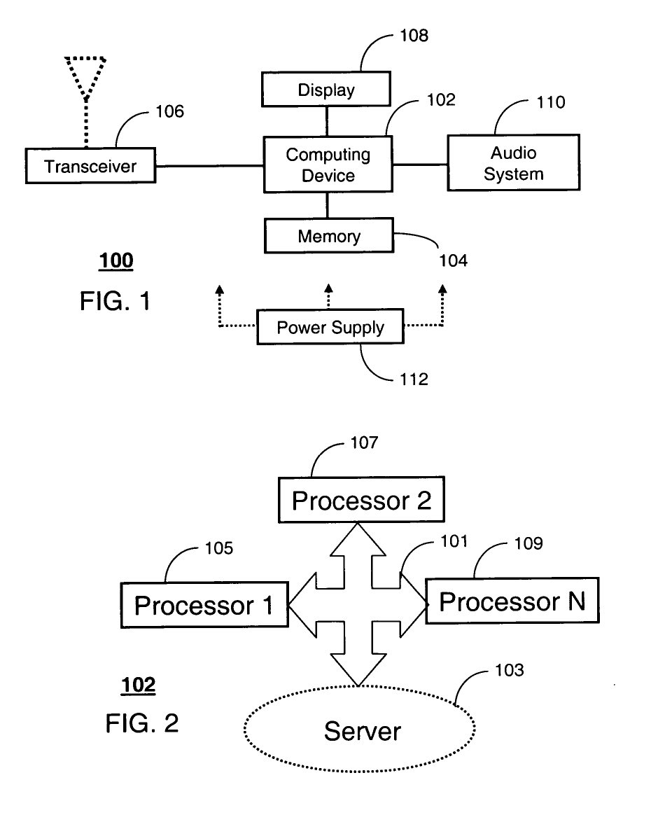

FIGS. 1-2 depict components of a device 100 according to an embodiment of the present invention. In a first embodiment, the device 100 comprises a computing device 102 coupled to a memory 104. The computing device 102 can include one or more conventional processors 103, 105, 107 109 (such as shown in FIG. 2) interconnected by a conventional bus 101 for processing information under the control of a multitasking operating system such as will be described below. Each of these processors 103, 105, 107 109 is coupled to the memory 104. Additionally, each processor 103, 105, 107 109 can be embodied in one or more conventional computing systems such as a computer, server, microprocessor, DSPs (Digital Signal Processor) and/or like computing technology as shown in FIG. 2. The memory 104 can include one or more conventional memory components such as Flash memory, a hard disk, RAM (Random Access Memory) or other suitable storage media.

In a supplemental embodiment, the device 100 can also include one or more among a group of circuits comprising a transceiver 106, a display 108, an audio system 110 and a power supply 112. The transceiver 106 can be a conventional wireless transceiver (as represented by the hashed antenna) and/or a wired transceiver. The wireless transceiver 106 can be used for communicating with a conventional radio communication system (not shown), while a wired transceiver 106 can be used to communicate with a conventional wired communication system such as a cable modem or a PSTN (Public Switch Telephone Network) interface. The display 108, the audio system 110 and the power supply each utilize conventional technology for conveying images and audible signals to a user of the device 100, and for supply power to the components of the device 100, respectively.

In the aforementioned embodiments, the device 100 can take the form of a conventional cellular phone or other radio communication devices such as a wireless PDA (Personal Digital Assistant) coupled to a wireless network operating according to a protocol such as EEE 802.11g. Alternatively, the device 100 can be used for interconnecting with the Internet wirelessly or by conventional wires. In any of these embodiments, the device 100 can be used for conventional voice communications, and/or a multimedia function such as streaming video and/or streaming audio data supplied by an entertainment source on the Internet or from, for example, cellular service provider.

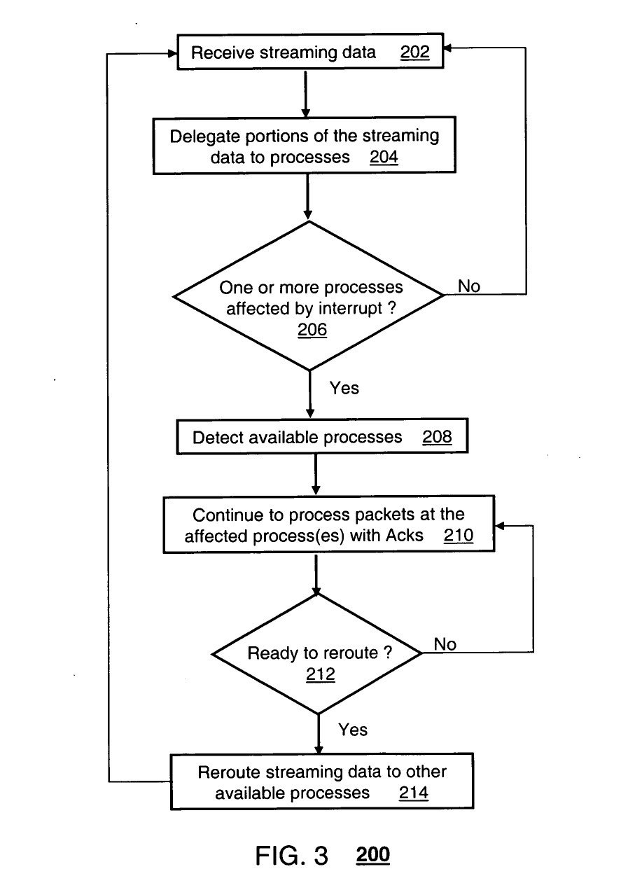

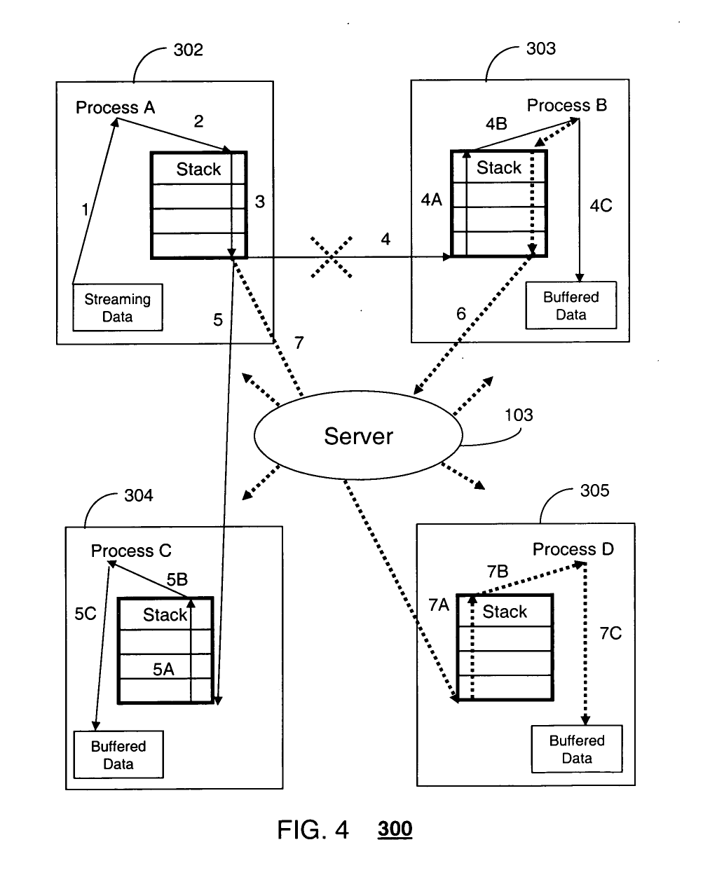

FIGS. 3-4 depict a flow chart of a method 200 and process diagram 300 operating on the device 100 according to an embodiment of the present invention. Device 100 operates in a multitasking environment managed by a conventional OS (Operating System) such as Linux or another suitable public or proprietary OS in accordance with method 200. In a supplemental embodiment, the OS includes a plurality of Processes 302-305 (depicted in FIG. 4) that intercommunicate with each other according to a conventional stacked multilayer protocol conforming to the well known OSI (Open Systems Interconnect) model.

Method 200 begins with step 202 where the computing device 102 receives streaming audio and/or video data for processing. The computing device 102 then proceeds to step 204 where it delegates portions of the streaming data to a number of processes. Referring to the process diagram 300 of FIG. 4, step 204 can be represented by Process 302A which delegates a portion of the streaming data to Processes 303-304. Alternatively, Process 302 could have processed a portion of the streaming data as well. Delegation step 204 takes place in a multilayer protocol environment as noted above. That is, upon receiving streaming data (link 1) Process 302 submits said data to the multilayer stack (link 2) which in turn works its way to the physical layer of said stack (link 3) until it reaches the stack of Processes 303-304, respectively, for processing and storing the delegated portions of the streaming data (as seen in links 4-5 and its sub-links 4A-4C and 5A-5C, respectively).

Referring back to FIG. 3, in step 206 the computing device 102 checks whether any of the aforementioned Processes 303-304 have been affected by an interruption that would inhibit further processing of the portions of streaming data delegated thereto. If no interruption is detected, then the computing device 102 continues to process the streaming data under the control of Process 302-304 as depicted in steps 202-204. If, on the other hand, an interruption is detected, then the computing device 102 is programmed to proceed to step 208 where it attempts to detect one or more available processes that can process the delegated portions of streaming data of the affected processes. An interruption can be due to, for example, a buffer overflow resulting from an over abundance of activities being managed by a particular process, and/or a higher priority request (such as an interrupt) taking priority over the delegated task of processing streaming data.

In the illustration of FIG. 4, Process 303 is assumed to have experienced the above-mentioned interruption. When this happens, Process 303 can communicate its condition to Process 302 in a number of potential embodiments. For example, communication can occur by way of the OSI protocol from Process 303 to Process 302, or from at session layer of each of these processes, or by way of the server 103 shown (see link 6) which broadcasts the condition of Process 303 to all processes. Streaming services provided by Process 303 are in turn suspended until such time as Process 303 recovers from the interruption. The detection step 206 occurs with sufficient time to execute a transition to the rerouting step 214 with a desired QoS (Quality of Service) level before streaming services of Process 303 are suspended.

After one or more affected processes have been detected in step 206, the computing device 102 proceeds to step 208 where it searches for processes available to carry out the streaming services of Process 303. For illustration, Process 305 is assumed to be an available process detected by the computing device 102. This search can be performed with the assistance of server 103, or Process 302 which, for example, can broadcast a request for assistance to the other processes. The transition to Process 305 occurs according to the sequence of steps 210-214. In step 210, Process 303 continues to process a predetermined number of packets of the portion of streaming data supplied thereto in order to provide a sufficient period of time to successfully execute the reroute step 214 at a desired QoS level.

The number of predetermined packets can be preset by a designer of each process or can be dynamically adjusted according to conditions monitored by, for example, server 103. In addition to processing packets, Process 303 provides one or more acknowledgments and corresponding time stamps for at least one of the predetermined number of packets. In step 212, the portion of streaming data assigned to Process 303 is rerouted to another process according to said acknowledgments and time stamps. The QoS level can be selected to maximize the use of available process bandwidth by prioritizing time-sensitive traffic between the processes of FIG. 4. QoS can define for instance traffic delivery priority, speed, latency, or latency variation. QoS techniques can be used in the transition steps 210-214 in order to maintain an acceptable audio and/or video quality level in streaming applications such as described above.

Once the computing device 102 determines that an appropriate QoS level has been achieved, it proceeds to step 214 where it reroutes the portion of streaming data delegated to Process 303 to Process 305 (as shown in links 5A-5C). Otherwise, step 212 proceeds to step 210 until such time that the computing device 102 determines an appropriate QoS level has been achieved.

It should be evident to the reader that the present invention can be realized in hardware, software, or a combination of hardware and software. Moreover, the present invention can be realized in a centralized fashion in one computing device 102, or in a distributed fashion where different elements are spread across several interconnected processors 103, 105, 107 109 such as shown in FIG. 2. Any kind of computer device or other apparatus adapted for carrying out the methods described herein is suited.

Additionally, the present invention can be embedded in a computer program product, which comprises all the features enabling the implementation of the methods described herein, and which when loaded in a computer system is able to carry out these methods as computer instructions. A computer program in the present context means any expression, in any language, code or notation, of a set of instructions intended to cause a system having an information processing capability to perform a particular function either directly or after either or both of the following: a) conversion to another language, code or notation; b) reproduction in a different material form.

It should be also evident that the present invention may be used for many applications. Thus, although the description is made for particular arrangements and methods, the intent and concept of the invention is suitable and applicable to other arrangements and applications not described herein. For example, where available processes are known prior to invoking method 200, method 200 can be reduced to steps 202, 204, 206, and 214 (thereby eliminating steps 208, 210 and 212) without departing from the scope of the claimed invention. It would be clear therefore to those skilled in the art that modifications to the disclosed embodiments described herein can be effected without departing from the spirit and scope of the invention.

Accordingly, the described embodiments ought to be construed to be merely illustrative of some of the more prominent features and applications of the invention. It should also be understood that the claims are intended to cover the structures described herein as performing the recited function and not only structural equivalents. Therefore, equivalent structures that read on the description are to be construed to be inclusive of the scope of the invention as defined in the following claims. Thus, reference should be made to the following claims, rather than to the foregoing specification, as indicating the scope of the invention.

What is claimed is:

1. In a multiprocessing system, a method comprising the steps of:
receiving streaming data;
delegating portions of the streaming data to a plurality of processes;
detecting that one or more of said processes is affected by an interruption that would inhibit further processing of the portions of streaming data delegated thereto; and
rerouting to other available processes the portions of streaming data supplied to the one or more affected processes at a desired quality of service level.

2. The method of claim 1, wherein the streaming data is at least one among a group of streaming data types comprising audio streaming data and video streaming data.

3. The method of claim 1, further comprising the step of detecting one or more processes available for processing portions of the streaming data.

4. The method of claim 1, wherein the step of detecting the one or more affected processes occurs with sufficient time to execute the rerouting step at the desired quality of service level.

5. The method of claim 1, further comprising the step of processing after the interruption has been detected at the one or more affected processes a predetermined number of packets of the portions of streaming data supplied thereto, wherein said processing step occurs for a sufficient period of time to execute the rerouting step at the desired quality of service level.

6. The method of claim 5, further comprising the steps of:
receiving from the one or more affected processes one or more acknowledgments and corresponding timestamps for each of the predetermined number of packets; and
rerouting to other available processes the portions of streaming data supplied to the one or more affected processes according to said acknowledgments and timestamps.

7. The method of claim 1, wherein the interruption is an overflow condition.

8. A computer-readable storage medium, comprising computer instructions for:
receiving streaming data;
delegating portions of the streaming data to a plurality of processes;
detecting that one or more of said processes is affected by an interruption that would inhibit further processing of the portions of streaming data delegated thereto; and
rerouting to other available processes the portions of streaming data supplied to the one or more affected processes at a desired quality of service level.

9. The computer-readable storage medium of claim 8, wherein the streaming data is at least one among a group of streaming data types comprising audio streaming data and video streaming data.

10. The computer-readable storage medium of claim 8, further comprising computer instructions for detecting one or more processes available for processing portions of the streaming data.

11. The computer-readable storage medium of claim 8, wherein the computer instructions for detecting the one or more affected processes occurs with sufficient time to execute the rerouting step at the desired quality of service level.

12. The computer-readable storage medium of claim 8, further comprising computer instructions for processing after the interruption has been detected at the one or more affected processes a predetermined number of packets of the portions of streaming data supplied thereto, wherein said processing step occurs for a sufficient period of time to execute the rerouting step at the desired quality of service level.

13. The computer-readable storage medium of claim 12, further comprising the steps of:
receiving from the one or more affected processes one or more acknowledgments and corresponding timestamps for each of a predetermined number of packets; and
rerouting to other available processes the portions of streaming data supplied to the one or more affected processes according to said acknowledgments and timestamps.

14. The computer-readable storage medium of claim 8, wherein the interruption is an overflow condition.

15. A device, comprising:
a memory; and
a computing device coupled to the memory, wherein said computing device is programmed to:
receive streaming data;
delegate portions of the streaming data to a plurality of processes operating on said computing device;
detect that one or more of said processes is affected by an interruption that would inhibit further processing of the portions of streaming data delegated thereto; and
reroute to other available processes the portions of streaming data supplied to the one or more affected processes at a desired quality of service level.

16. The device of claim 15, wherein communication between processes takes according to a multilayer communication protocol.

17. The device of claim 15, wherein said computing device comprises one or more processors, wherein one or more of the foregoing steps is controlled by a server of the one or more processors, and wherein said device further comprises one or more among a group of circuits comprising a transceiver for communicating with a communication system, a display for conveying images to a user of the device, and an audio system for conveying audible signals to the user.

18. The device of claim 15, wherein the step to detect the one or more affected processes occurs with sufficient time to execute the step to reroute at the desired quality of service level.

19. The device of claim 15, further comprising the step of processing after the interruption has been detected at the one or more affected processes a predetermined number of packets of the portions of streaming data supplied thereto, wherein said processing step occurs for a sufficient period of time to execute the rerouting step at the desired quality of service level.

20. The device of claim 19, further comprising the steps of:
receiving from the one or more affected processes one or more acknowledgments and timestamps for at least one of the predetermined number of packets;
rerouting to other available processes the portions of streaming data supplied to the one or more affected processes according to said acknowledgments and timestamps; and
suspending services provided by the one or more affected processes until said processes recover from the interruption.
